(19) United States
(12) Patent Application Publication
(10) Pub. No.: US 2009/0284335 A1
(43) Pub. Date: Nov. 19, 2009

(54) ELECTROMAGNETIC SWITCH AND MAKING METHOD THEREOF

(75) Inventors: YEONG BONG KIM, Chungcheongbuk-do (KR); Hyun Kil Cho, Chungcheongbuk-do (KR); Hong Tae Park, Chungcheongbuk-do (KR)

Correspondence Address: LEE, HONG, DEGERMAN, KANG & WAIMEY, 660 S. FIGUEROA STREET, Suite 2300, LOS ANGELES, CA, 90017, US

(73) Assignee: LS INDUSTRIAL SYSTEMS CO., LTD.

(21) Appl. No.: 12/463,248

(22) Filed: May 8, 2009

(30) Foreign Application Priority Data
May 15, 2008 (KR) 10-2008-0045209

(51) Int. Cl. H01H 9/30

(52) U.S. Cl. 335/201

(57) ABSTRACT

The present invention provides a low-noise electromagnetic switch applied to an electric car, whereby noise generated by vibration from an inner switch is prevented from being transmitted to the outside box by filling up a filler-up material between the inner switch and the outside box.

### CROSS-REFERENCE TO RELATED APPLICATION

The present application is based on, and claims priority from, Korean Application Number 10-2008-0045209, filed May 15, 2008, the disclosure of which is incorporated by reference herein in its entirety.

### BACKGROUND

The present disclosure relates to an electromagnetic switch for opening or shutting off a direct current power, and more particularly to an electromagnetic switch and a making method thereof. The electromagnetic switch is installed between a condenser and a power converter in an electric vehicle such as a hybrid car, a fuel-cell car, a golf cart or an electric forklift to supply a direct current (DC) power from the condenser to a DC converter or stop the DC power.

The electromagnetic switch installed between a DC generator and an inverter that converts a DC power to an alternating current (AC) power of commercial frequency in an environment-friendly generating system such as a solar generator or a wind power generator also functions to supply a DC power to a DC converter or stop the DC power.

Particularly, it is essential that the electromagnetic switch used in the electric car be capable of minimizing occurrence of noise for maintaining a silence in a room.

FIG. is a cross-sectional view illustrating configuration, noise generating location and vibration transmission route of an electromagnetic switch according to the prior art.

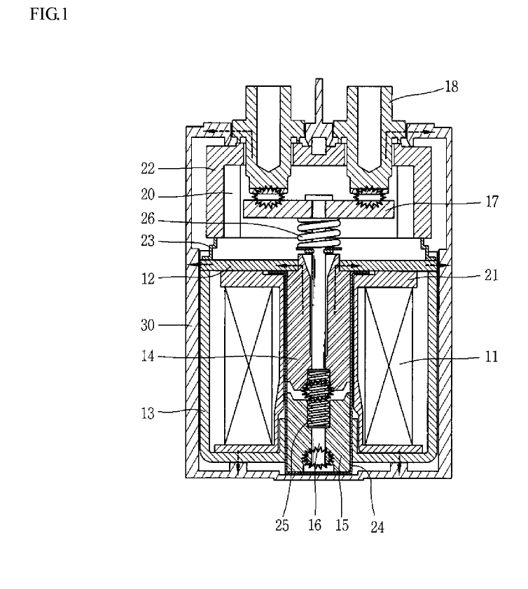

Referring to FIG. 1, an electromagnetic switch for opening or shutting-off of a DC power according to an imaginary embodiment will be described in order to compare with the present invention.

The conventional electromagnetic switch includes a movable unit that is movable and having a contact point, a gas sealing unit for air-tightly sealing a fill-up space in which gas for arc distinguishing is filled, and a magnetic driving unit providing a driving power for driving the movable unit.

The movable unit is connected to a lower section of a shaft 16 for linearly moving with the shaft 16, and includes a cylinder-shaped movable core 15 capable of linearly moving by magnetic suction force from the magnetic driving unit, and a movable contact point 17 forming an electric contact unit by being connected to an upper end of the shaft 16.

A stationary core 14 is positioned at a location opposite to the movable core 15 for wrapping the shaft 16. The stationary core 14 and the movable core 15 constitute a movable circuit of magnetic flex along with upper and lower yokes of the magnetic driving unit (described later). The gas sealing unit is provided about an upper portion of the movable unit in order to form an arc distinguishing chamber 20 that tightly closes and keeps the arc distinguishing gas of the electromagnetic switch.

The gas sealing unit includes a tubular insulation member 22, a pair of stationary electrodes 18 extensively connecting interior and exterior parts of the insulation member 22 so as to penetrate the insulation member 22 and air-tightly coupled to the insulation member 22, a tubular air-tight sealing member 23 formed with a sill for air-tightly sealing the insulation member 22 and an upper yoke (described later), and a non-magnetic sealing can 24 air-tightly installed to wrap the movable core 15 and the stationary core 14. The pair of stationary electrodes is electrically connected to a DC power side and a load side via, for example, an electrical wire.

The magnetic driving unit generates a magnetic suction force to drive the movable core 15 and the movable contact point 17 (described later), whereby the electromagnetic switch is opened or shut off. The magnetic driving unit includes an excitation coil 11, an upper yoke 12 and a lower yoke 13.

The excitation coil 11 is a driving coil provided at a lower section of the electromagnetic switch, and is magnetized when connected to a signal line (not shown) and applied with a current, and demagnetized when the current is cut off. The excitation coil 11 in the electromagnetic switch generates a magnetic suction force to provide a driving force to the driving unit.

The upper yoke 12 is installed at an upper section of the excitation coil 11. The upper yoke 12 constitutes part of a mobile route of magnetic flux along with the movable core 15 and the stationary core 14 when the excitation core 11 is magnetized. The lower yoke 13 forms a mobile route of magnetic flux along with the upper yoke 12, the movable core 15 and the stationary core 14 when the excitation core 11 is magnetized.

Unexplained reference numeral 21 in FIG.1 refers to a bobbin supporting the excitation core 11 and capable of wrapping a surrounding of the excitation core 11. Unexplained reference numeral 25 in FIG. 1 refers to a return spring installed between the movable core 15 and the stationary core 14 to provide a resilience for returning the movable core 15 to an original position (i.e., to a position distanced from the stationary core 14 when the excitation core 11 is demagnetized.

Unexplained reference numeral 26 in FIG.1 defines a contact spring for maintaining a contact pressure between the movable contact point 17 and a stationary contact point (no reference numeral defined) when the movable contact point 17 contacts the stationary contact point. Unexplained reference numeral 30 in FIG. 1 defines an outside box accommodating a conventional electromagnetic switch.

Now, operation of the conventional electromagnetic switch thus constructed will be described.

The excitation core 11 is magnetized if a current is made to flow in a signal line (not shown) connected to the excitation core 11. A magnetic flux generated by the excitation core 11 moves along a mobile route formed by the movable core 15, the stationary core 14, the upper yoke 12 and the lower yoke 13 to form a closed circuit of the magnetic flux. At this time, the movable core 15 linearly moves being contacted by the stationary core 14, whereby a shaft 16 so connected as to move along with the movable core 15 is lifted up in FIG. 1. The movable contact point 17 installed at an upper end of the shaft 16 is brought into contact with the stationary contact point which is opposite to the movable contact point to allow the DC power side and the load side to contact each other, thereby the DC power being supplied. This situation is called a turned-on operation state.

The excitation core 11 is demagnetized if a current is made to be cut off from a signal line (not shown) connected to the excitation core 11. The movable core 15 returns to an original position distanced from the stationary core 14 by a return spring 25 as the excitation core 11 is demagnetized. As a result, the movable contact point 17 installed at the upper end of the shaft 16 is separated from the opposite stationary contact point of the stationary electrodes 18. Then, the DC power side and the load side are separated, there by the DC power being cut off. This situation is called a turned-off operation state.

The conventional electromagnetic switch thus constructed is such that a turned-on shock sound is generated by a contact collision between the movable core 15 and the stationary core 14 when in the turned-on operation state. Furthermore, the conventional electromagnetic switch is such that a turned-on shock sound is generated by a contact collision between the stationary contact point attached to a lower end of the stationary electrode 18 and the movable contact point 17. Vibration generated by the contact collision of the stationary core 14 and the movable core 15 is transmitted to an outside box 30 via the stationary core 14 and the upper yoke 26 as shown in an arrow. The turned-on shock sound generated by the contact collision of the stationary contact point and the movable contact point 17 is transmitted to the stationary electrodes 18, the insulation member 22 and the outside box 30.

The problem is that the turned-on shock sound is thereafter transmitted to a body of an electric car installed with an electromagnetic switch to generate noise inside the car.

Furthermore, the conventional electromagnetic switch is such that a turned-off shock sound is generated by a contact collision between the movable core 15 and the sealing can 24 when in a turned-off operation state. The turned-off shock sound thus created is transmitted to the outside box 30 via the stationary core 14 and the lower yoke 13 as shown in an arrow.

The problem is that the turned-off shock sound is thereafter transmitted to a body of an electric car installed with an electromagnetic switch to generate noise inside the car.

The generation of turned-on and turned-off shock sound of the electromagnetic switch may cause a serious dissatisfaction to passengers inside an electric car which requires a silent environment inside the car.

### SUMMARY

The present inventors have recognized certain drawbacks of the related art as explained above. Upon such recognition, the following concepts and features have been conceived. Thus, the present disclosure intends to solve the aforementioned drawbacks and to provide an electromagnetic switch and a making method thereof capable of shutting off transmission of vibration caused by turned-on and turned-off shock sound in the electromagnetic switch to thereby cut down on generation of noise.

According to one general aspect of the present disclosure, there is provided an electromagnetic switch, comprising: an inner switch including a movable unit that is movable and having a contact point, a gas sealing unit for air-tightly sealing a fill-up space in which gas for arc distinguishing is filled, and a magnetic driving unit providing a driving power for driving the movable unit; an outside box accommodating the inner switch; and a fill-up material filled in between the inner switch and the outside box to prevent noise generated by the inner switch from being transmitted by vibration to the outside box.

In some exemplary embodiments, the fill-up material may be liquefied curable resin. The liquefied curing resin may be one of room temperature polymer resin, thermosetting resin, or ultraviolet polymer resin. The liquefied curable resin may be one of phenol resin, urea resin, melamine resin, unsaturated polyester resin, epoxy resin, diaryl phthalate resin, polyurethane resin, silicone resin or polyimide resin.

According to another general aspect of the present disclosure, there is provided a making method of an electromagnetic switch, comprising: assembling and preparing an inner switch including a movable unit a movable unit that is movable and having a contact point, a gas sealing unit for air-tightly sealing a fill-up space in which gas for arc distinguishing is filled, and a magnetic driving unit providing a driving power for driving the movable unit; preparing an outside box accommodating the inner switch; positioning the inner switch and the outside box each spaced apart at a predetermined distance; discharging, by a discharger, liquefied curable resin into a space formed by the electromagnetic switch and the outside box each spaced apart at a predetermined distance; and curing the liquefied curable resin.

In some exemplary embodiments, the step of positioning the inner switch and the outside box each spaced apart at a predetermined distance may be performed by distancing the inner switch from the outside box using a lid having an extension spacer inserted between the inner switch and the outside box.

In some exemplary embodiments, the step of positioning the inner switch and the outside box each spaced apart at a predetermined distance may be performed by distancing the inner switch from the outside box using a position fixation mechanism for fixing the inner switch at a position distanced from the outside box.

In some exemplary embodiments, the step of positioning the inner switch and the outside box each spaced apart at a predetermined distance may be performed by maintaining the inner switch from the outside box at a predetermined distance using a hand.

In some exemplary embodiments, the step of positioning the inner switch and the outside box each spaced apart at a predetermined distance may be performed by inserting a plurality of rubber spacers between the inner switch and the outside box.

In some exemplary embodiments, the step of curing the liquefied curable resin may include curing the liquefied curable resin at a room temperature.

In some exemplary embodiments, the step of curing the liquefied curable resin may include curing the liquefied curable resin by heating.

In some exemplary embodiments, the step of curing the liquefied curable resin may include curing the liquefied curable resin by irradiation of ultraviolet ray.

### BRIEF DESCRIPTION OF THE DRAWTINGS

FIG. 1 is a cross-sectional view illustrating configuration of a DC electromagnetic switch, a noise generation position and a vibration transmission route according to prior art.

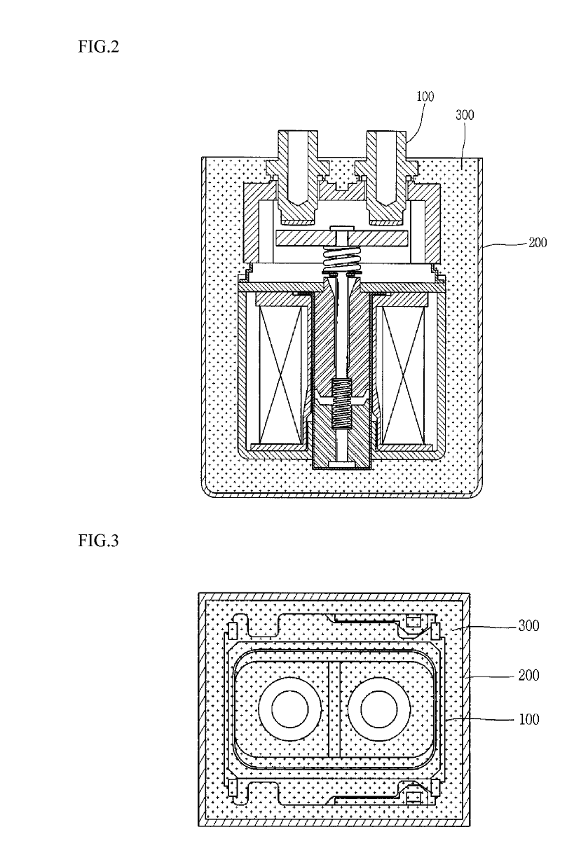

FIG. 2 is a longitudinal cross-sectional view illustrating a DC low-noise electromagnetic switch according to the present invention.

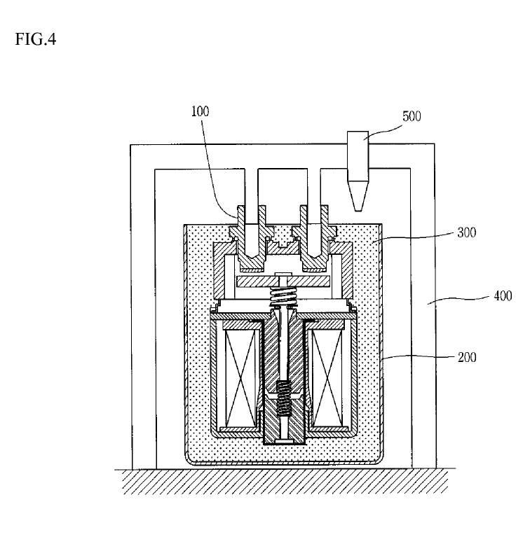

FIG. 3 is a plan illustrating configuration of a DC low-noise electromagnetic switch according to the present invention.

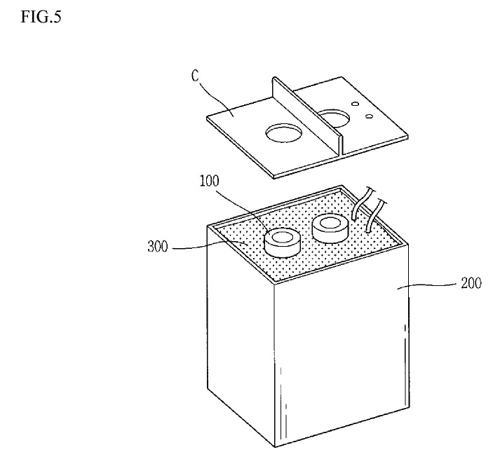

FIG. 4 is a view illustrating a making method of a low-noise DC electromagnetic switch using a position determination support for maintaining a predetermined distance between an inner switch and an outside box.

FIG. 5 is an exploded perspective view of a lid illustrating an exterior look of an electromagnetic switch made with a lid separated from a DC low-noise electromagnetic switch according to the present invention.

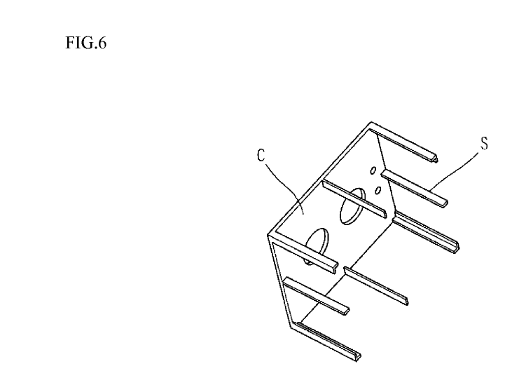

FIG. 6 is a perspective view illustrating a part in which an exemplary lid equipped with a spacer is shown inside out.

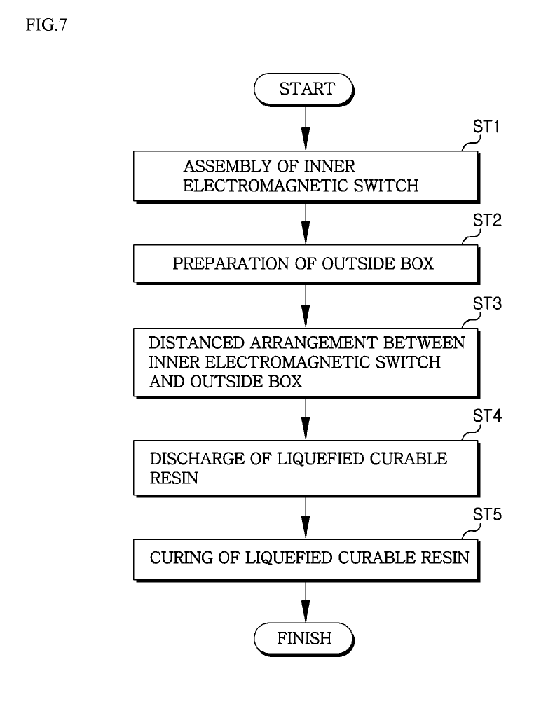

FIG. 7 is a flowchart illustrating a making method of a low-noise electromagnetic switch according to the present invention.

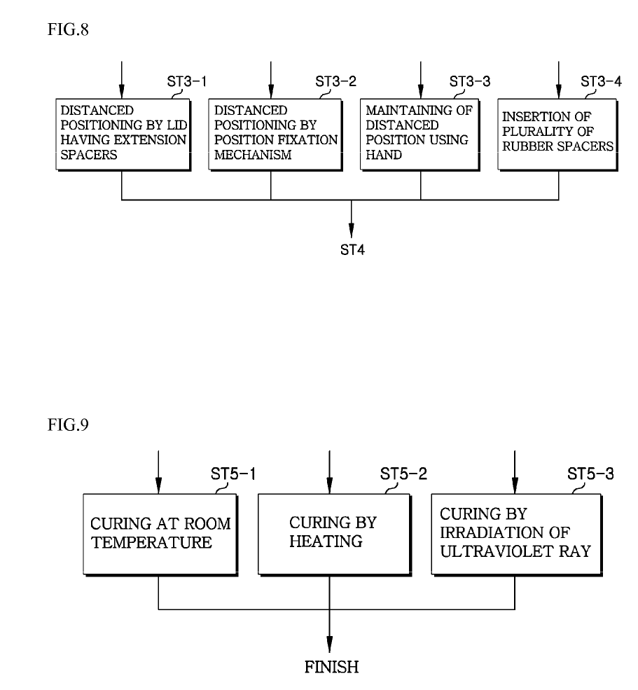

FIG. 8 is a flow chart illustrating an exemplary detailed selective method of step 3 in the making method of the low-noise electromagnetic switch in FIG. 7 according to the present invention.

FIG. 9 is a flow chart illustrating an exemplary detailed selective method of step 5 in the making method of the low-noise electromagnetic switch in FIG. 7 according to the present invention.

### DETAILED DESCRIPTION

Configuration and operational effect of the present invention for accomplishing the object of the present invention will be further understood by the exemplary embodiments relative to the following detailed description with reference to the accompanying drawings.

Configuration of DC low-noise electromagnetic switch according to the present invention will be described with reference to FIG. 2 illustrating a longitudinal cross-sectional view of the DC low-noise electromagnetic switch and FIG. 3 illustrating a plan of the DC low-noise electromagnetic switch according to the present invention.

The DC low-noise electromagnetic switch according to the present invention includes an inner switch 100, an outside box 200 and a filler-up material 300.

The inner switch 100 may include a movable unit that is movable and having a contact point, a gas sealing unit for air-tightly sealing a fill-up space in which gas for arc distinguishing is filled, and a magnetic driving unit providing a driving power for driving the movable unit. The inner switch will be omitted in description thereof as it has been already expounded in the explanation of the prior art.

The inner switch 100 according to the present invention is encased by filler-up material so that the switch 100 is hard to be vibrated, whereby turned-on and turned-off shock sound generated by the inner switch 100 is not transmitted to the outside box 200. The vibration-less outside box generates no phenomenon of the vibration being transmitted to an electric car installed with an electromagnetic switch and no phenomenon of noise being transmitted to an interior of the electric car, either. Therefore, the shut-out of turned-on and turned-off shock sound from the electromagnetic switch can provide pleasant noiseless environment inside the electric car.

The outside box 200 is accommodated inside the inner switch 100. The filer-up material 300 is filled up between the inner switch 100 and the outside box 300 in order to prevent the vibration generated by the inner switch 100 from being transmitted to the outside box 200.

The fill-up material 300 is preferably comprised of liquefied curable resin. The liquefied curing resin may be one of room temperature polymer resin, thermosetting resin, or ultraviolet polymer resin. To be more specific, the liquefied curable resin may be one of phenol resin, urea resin, melamine resin, unsaturated polyester resin, epoxy resin, diaryl phthalate resin, polyurethane resin, silicone resin or polyimide resin.

As a result, the low-noise electromagnetic switch according to the present invention is disposed with a filler-up material filled up between the inner switch and the outside box. The low-noise electromagnetic switch is such that the turned-on or turned-off shock sound generated from the inner switch is not transmitted to the outside box to thereby shut off the turned-on or turned-off noise

The filler-up material according to the low-noise electromagnetic switch is liquefied curable resin, such that the material is easy to be filled up between the inner switch and the outside box and the cured resin can effectively shut off the vibration transmission.

As noted above, the liquefied curable resin is one of the room temperature polymer resin, the thermosetting resin, or the ultraviolet polymer resin. Therefore, there is an advantage of selectively utilizing, by a user, a resin that can be cured at a room temperature, a resin that can be cured by being heated and cooled, and a resin that can be cured by irradiating ultraviolet ray. The liquefied curable resin according to the present invention is available in various types such that a user may selectively utilize any one of various liquefied curable resins.

Meanwhile, FIG. 4 is a view illustrating a making method of a low-noise DC electromagnetic switch using a position determination support as a position fixation mechanism for maintaining a predetermined distance between an inner switch and an outside box, FIG. 5 is an exploded perspective view of a lid illustrating an exterior look of an electromagnetic switch made with a lid separated from a DC low-noise electromagnetic switch according to the present invention, FIG. 6 is a perspective view illustrating a part in which an exemplary lid equipped with a spacer is shown inside out, FIG. 7 is a flowchart illustrating a making method of a low-noise electromagnetic switch according to the present invention, FIG. 8 is a flow chart illustrating an exemplary detailed selective method of step 3 in the making method of the low-noise electromagnetic switch in FIG. 7 according to the present invention, and FIG. 9 is a flow chart illustrating an exemplary detailed selective method of step 5 in the making method of the low-noise electromagnetic switch in FIG. 7 according to the present invention. Now, the making method of low-noise electromagnetic switch according to the present invention will be described in detail with reference to the above-mentioned drawings.

Referring to FIG. 7, the making method of low-noise electromagnetic switch comprises: assembling and preparing an inner switch (100 in FIG. 2) including a movable unit a movable unit that is movable and having a contact point, a gas sealing unit for air-tightly sealing a fill-up space in which gas for arc distinguishing is filled, and a magnetic driving unit providing a driving power for driving the movable unit (ST1); preparing an outside box (200 in FIG. 2) accommodating the inner switch (ST2); positioning the inner switch and the outside box each spaced apart at a predetermined distance (ST3); discharging, by a discharger, liquefied curable resin into a space formed by the electromagnetic switch and the outside box each spaced apart at a predetermined distance (ST4); and curing the liquefied curable resin (ST5).

In the step (ST1) of assembling and preparing an inner switch (100 in FIG. 2), the inner switch that includes a movable unit, a gas sealing unit and a magnetic driving unit is assemble and prepared with reference to FIG. 1.

In the step (ST2) of preparing an outside box, the outside box (200 in FIG. 2) is made in advance and prepared.

The step (ST3) of positioning the inner switch and the outside box each spaced apart at a predetermined distance is a step of preventing a phenomenon of an outside lateral wall of the inner switch from being in contact with an inside lateral wall of the outside box. The phenomenon of being contacted therebetween is created in the midst of the inner switch being pushed and moved during discharge of the liquefied curable resin.

The step of positioning the inner switch and the outside box each spaced apart at a predetermined distance (ST3) is performed by distancing (ST3-1 in FIG. 8) the inner switch from the outside box using a lid (C) having an extension spacer (S) inserted between the inner switch and the outside box (FIG. 6).

The position of the extension spacer (S) having a predetermined width between the inner switch and the outside box causes the inner switch to be separated from the outside box at a predetermined distance, whereby a space can be obtained for the liquefied curable resin to be discharged and cured between the inner switch and the outside box.

In another method, the step (ST3) of positioning the inner switch and the outside box each spaced apart at a predetermined distance may be performed (ST3-2 in FIG. 8) by distancing the inner switch from the outside box using a position fixation mechanism (400 in FIG. 4) for fixing the inner switch at a position distanced from the outside box.

Referring to FIG. 4, the outside box is placed on a floor surface of a manufacturer or a floor surface of a work bench (a bottom part on which the position fixation mechanism 400 is placed. see oblique lines of FIG. 4). The inner switch is inserted into the outside box to provide a space predetermined between the inner switch and the outside box. The position fixation mechanism 400 is installed on the floor surface for fixing a position of the outside box or the inner switch. The position fixation mechanism 400 is provided thereon with an extension access unit that can be inserted into a fixation electrode of the inner switch. The extension access unit may be inserted into the fixation electrode of the inner switch to maintain a position of the outside box or the inner switch.

In still another method, the step of positioning the inner switch and the outside box each spaced apart at a predetermined distance may be realized by performing a step (ST-3) of maintaining the inner switch from the outside box at a predetermined distance using a hand.

In still further another method, the step of positioning the inner switch and the outside box each spaced apart at a predetermined distance (ST3) may be performed by inserting a plurality of rubber spacers between the inner switch and the outside box. In other words, the inner switch is separated from the outside box, and a plurality of rectangular rubber pieces (not shown) is inserted between the inner switch and the outside box to thereby maintain a predetermined space therebetween. A length-wise and breadth-wise dimension of each rectangular rubber piece is smaller than that of the space formed between the inner switch and the outside box.

The making method of low-noise electromagnetic switch is realized by discharging the liquefied curable resin into a space between the inner switch and the outside box each spaced apart at a predetermined distance while the inner switch and the outside box are separated. Therefore, it is possible to manufacture a low-noise electromagnetic switch according to the making method of the electromagnetic switch according to the present invention.

The step (ST4) of discharging the liquefied curable resin is realized by discharge of the liquefied curable resin by a discharger (500 in FIG. 4) into a space formed by the inner switch selectively provided from the plurality of methods (ST3-1, ST3-2, ST3-3 and ST3-4) and the outside box. The discharger may be a hydraulic or air-pressure discharger easily available in the market.

The step (ST5) of curing the liquefied curable resin may be selectively performed using a step (ST5-1) of FIG. 9 in which the liquefied curable resin is cured at a room temperature. The liquefied curable resin cured at the room temperature may be exemplified by silicon resin, so-called silicon.

The step (ST5) of curing the liquefied curable resin may be selectively performed by heating as shown in step (ST5-2) of FIG. 9. The liquefied curable resin that is cured by heating may be exemplified by phenol resin, urea resin, melamine resin and epoxy resin.

The step (ST5) of curing the liquefied curable resin may be selectively performed by, for example, irradiation of ultraviolet ray as shown in step (ST5-3) of FIG. 9. The liquefied curable resin cured by irradiation of ultraviolet may include oligomer, monomer and photo initiator. The oligomer may include epoxy resin, polyester and urethane group acrylate. The monomer may include multi-functional or mono-functional acrylate. The photo initiator may include various initiators including benzoin ether and benzophenone group.

As illustrated in FIG. 5, the low-noise electromagnetic switch manufactured by the making methods according to the present invention includes the filler-up material 300 formed by curing of the liquefied curable resin between the inner switch 100 and the outside box 200, and is illustrated with the lid (C) removed to show the inner structure thereof.

Therefore, a simple covering by way of a lid can distance the inner switch from the outside box according to the making method of electromagnetic switch of the present invention.

Furthermore, the positioning of the inner switch and the outside box each spaced apart at a predetermined distance is performed by maintaining the inner switch from the outside box at a predetermined distance using a hand, such that there is no need of separate exclusive equipment, thereby making it possible to manufacture the low-noise electromagnetic switch simply at a low cost.

Furthermore, the making method of electromagnetic switch according to the present invention makes it possible to enhance the manufacturing convenience because the manufacturing processes can be simplified.

Still furthermore, the liquefied curable resin can be cured by various curing methods to increase the curing convenience and swiftness.

What is claimed is:

1. An electromagnetic switch, comprising: an inner switch including a movable unit a movable unit that is movable and having a contact point, a gas sealing unit for air-tightly sealing a fill-up space in which gas for arc distinguishing is filled, and a magnetic driving unit providing a driving power for driving the movable unit; an outside box accommodating the inner switch; and a fill-up material filled in between the inner switch and the outside box to prevent noise generated by the inner switch from being transmitted by vibration to the outside box.

2. The switch of claim 1, wherein the fill-up material is liquefied curable resin.

3. The switch of claim 2, wherein the liquefied curing resin is one of room temperature polymer resin, thermosetting resin, or ultraviolet polymer resin.

4. The switch of claim 2, wherein the liquefied curable resin is one of phenol resin, urea resin, melamine resin, unsaturated polyester resin, epoxy resin, diaryl phthalate resin, polyurethane resin, silicone resin or polyimide resin.

5. A making method of an electromagnetic switch, comprising: assembling and preparing an inner switch including a movable unit a movable unit that is movable and having a contact point, a gas sealing unit for air-tightly sealing a fill-up space in which gas for arc distinguishing is filled, and a magnetic driving unit providing a driving power for driving the movable unit; preparing an outside box accommodating the inner switch; positioning the inner switch and the outside box each spaced apart at a predetermined distance; discharging, by a discharger, liquefied curable resin into a space formed by the electromagnetic switch and the outside box each spaced apart at a predetermined distance; and curing the liquefied curable resin.

6. The method of claim 1, wherein the step of positioning the inner switch and the outside box each spaced apart at a predetermined distance is performed by distancing the inner switch from the outside box using a lid having an extension spacer inserted between the inner switch and the outside box.

7. The method of claim 5, wherein the step of positioning the inner switch and the outside box each spaced apart at a predetermined distance is performed by distancing the inner switch from the outside box using a position fixation mechanism for fixing the inner switch at a position distanced from the outside box.

8. The method of claim 5, wherein the step of positioning the inner switch and the outside box each spaced apart at a predetermined distance is performed by maintaining the inner switch from the outside box at a predetermined distance using a hand.

9. The method of claim 5, wherein the step of positioning the inner switch and the outside box each spaced apart at a predetermined distance is performed by inserting a plurality of rubber spacers between the inner switch and the outside box.

10. The method of claim 5, wherein the step of curing the liquefied curable resin includes curing the liquefied curable resin at a room temperature.

11. The method of claim 5, wherein the step of curing the liquefied curable resin includes curing the liquefied curable resin by heating.

12. The method of claim 5, wherein the step of curing the liquefied curable resin includes curing the liquefied curable resin by irradiation of ultraviolet ray.
